(19) United States
(12) Patent Application Publication
(10) Pub. No.: US 2020/0269507 A1
(43) Pub. Date: Aug. 27, 2020

(54) AUTOMATIC FILAMENT CHANGER

(71) Applicant: Ohmnilabs, Inc., Santa Clara, CA (US)

(72) Inventor: Jared Go, Mountain View, CA (US)

(21) Appl. No.: 16/287,090

(22) Filed: Feb. 27, 2019

(51) Int. Cl. B29C 64/321; B29C 64/118; B29C 64/20; B29C 64/393; B33Y 10/00; B33Y 30/00; B33Y 50/02

(52) U.S. Cl. CPC B29C 64/321; B29C 64/118; B29C 64/20; B33Y 50/02; B33Y 10/00; B33Y 30/00; B29C 64/393

(57) ABSTRACT

A method and apparatus for automatic filament change out without interruption to a 3D print task. As a filament roll runs out of filament, the tail end is detected and an automatic filament changer selects and feeds a new strand of filament to a 3D printer's extruder. The empty filament roll is replaced, the automatic filament changer can switch to a different filament roll when the new filament roll is empty, and 3D printing can run continuously with no interruptions to change out filament.

### BACKGROUND

A typical three dimensional (3D) printer uses spools of plastic filament as input. This plastic filament comes on rolls in various sizes. Rolls are typically 1 kg, or sometimes 3 or 5 kg. The plastic filament may be various types of thermoplastics such as PLA, ABS, PETG, Nylon, etc.

During the operation of the 3D printer, the filament is consumed by being re-melted and extruded into fine layers to build up a part. If the filament runs out, then typically one of two things happen. Either A) the printer does not detect this and continues without filament, causing a failed print, or B) the printer has filament out detection and automatically stops, parks the extruder head in a corner, and waits for an operator to manually change out the filament and signal the printer to continue.

For mass produced 3D printed parts, both cases are undesired. In case A), the print is unrecoverable, time is wasted, and the extruded plastic is scrapped. In case B) the printer is not operating for some time and thus downtime is incurred. Manual labor is also required to change the filament and continue the print, which scales poorly. Filament rolls may take a few minutes to swap, and the printer calibration may be impacted while the operator manipulates the machine in the middle of a print.

Furthermore, the inability to automatically change filament leads to significant waste. If a 1 kg spool used for batched prints of 250 g has only 150 g left, it would have to be set aside as waste. There is a need for a solution that provides seamless, automatic switching between filament rolls.

### BRIEF SUMMARY

This disclosure relates to a method for automatic filament change, comprising loading a plurality of filament rolls into a queue. Each of the filament rolls contains a strand of filament for use as a print medium for a three-dimensional printer. The method further comprises feeding a lead end of the strand of filament to the three-dimensional printer and detecting a tail end of the strand of filament as the filament roll runs out. The method then comprises automatically feeding the lead end of a next strand of filament from a next filament roll immediately behind the tail end of the strand of filament from the filament roll just emptied. Finally, the method comprises repeating the three previous steps on condition that at least one of the filament rolls in the queue is not empty.

This disclosure further relates to an apparatus for automatic filament changer 212 comprising a plurality of input ports that each accept a strand of filament from a filament roll in a queue. The apparatus further comprises an output part that directs the strand of filament to a three-dimensional printer. The apparatus further comprises an end sensor capable of detecting the end of the strand of filament as it passes out of the input port. The apparatus further comprises a feed motor that propels the strand of filament through the input port and the output port. The feed motor speed and rotational direction are controlled by a feed motor controller. The apparatus further comprises a selection motor that aligns the output port with one of the input ports. The distance and direction of motion generated by the selection motor to align the input port selected with the output port is controlled by a selection motor controller.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an automatic filament change method 100 in accordance with one embodiment.

FIG. 2 illustrates a 3D printer system with automatic filament change apparatus 200 in accordance with one embodiment.

FIG. 3 illustrates an automatic filament changer 300 in accordance with one embodiment.

FIG. 4 shows automatic filament change illustration 400 in accordance with one embodiment.

FIG. 5 shows automatic filament change illustration 500 in accordance with one embodiment.

FIG. 6 shows automatic filament change illustration 600 in accordance with one embodiment.

FIG. 7 illustrates a rotary output port 700 in accordance with one embodiment.

FIG. 8 illustrates a rotary output port 800 in accordance with one embodiment.

FIG. 9 illustrates a 3D printer system with weight sensor 900 in accordance with one embodiment.

FIG. 10 illustrates an automatic filament change apparatus alarm/notification system 1000 in accordance with one embodiment.

### DETAILED DESCRIPTION

This disclosure relates to a method and apparatus for queuing three dimensional (3D) printing filament rolls of any size and automatically switching to a new roll when the current one is finished, with no interruption in the printing process. In a typical embodiment, two spools may be queued, and a blade may be used to cut the tail end of the current strand of filament and the leading end of the next strand of filament clean before switching to the next filament roll.

As the printer continues to print, an operator may remove the empty filament roll and replace it with a new filament roll. Once the second filament roll is empty, this new filament roll may be switched to automatically. This process may continue indefinitely so as to operate the printer continuously with no downtime from filament changes.

The primary solution disclosed herein may provide a continuous feed of filament of any type and color. Other embodiments of the automatic filament changer may be used to control switching between filament colors, filament materials, or any other application where automated filament switching may be desired.

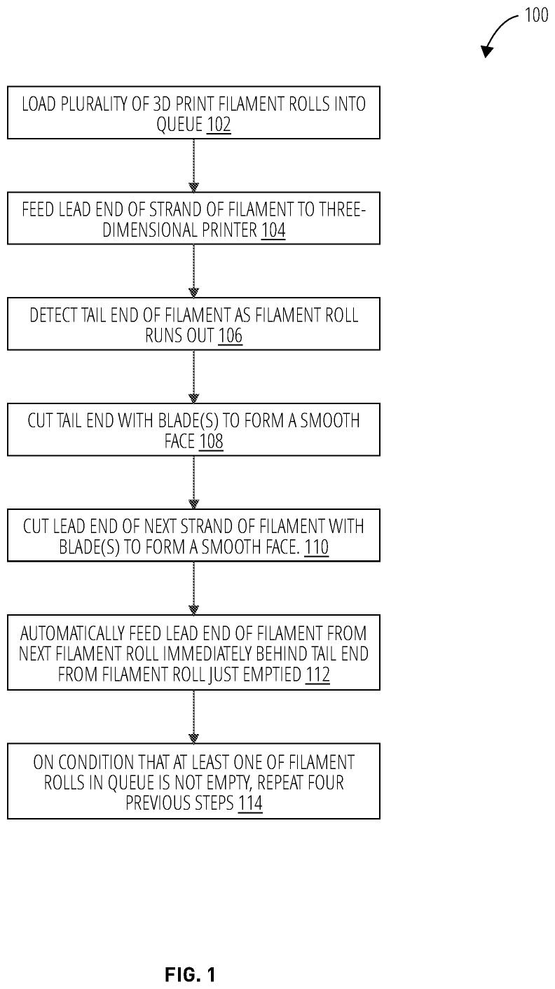

Referring to FIG. 1, an automatic filament change method 100 begins when a plurality of 3D printing filament rolls are loaded into a queue (block 102). In one embodiment, this may comprise two filament rolls. The lead end of one of the strands of filament from one of the rolls may be fed to the extruder of a 3D printer (block 104).

As this strand of filament runs out, the tail end may be detected as it passes an end sensor (block 106). The end sensor may be an optical sensor, a microswitch, or similar sensor. The tail end may be cut by one or more blades to form a smooth face (block 108).

The lead end of the next strand of filament may also be cut to form a smooth face (block 110). The lead end of the next strand of filament may be automatically fed to the extruder, immediately behind the tail end of the previous strand of filament (block 112). While this filament roll is in use, an operator may replace the empty filament roll. As long as at least one filament roll in the queue is not empty, this process may be repeated, allowing for continuous, uninterrupted printing (block 114).

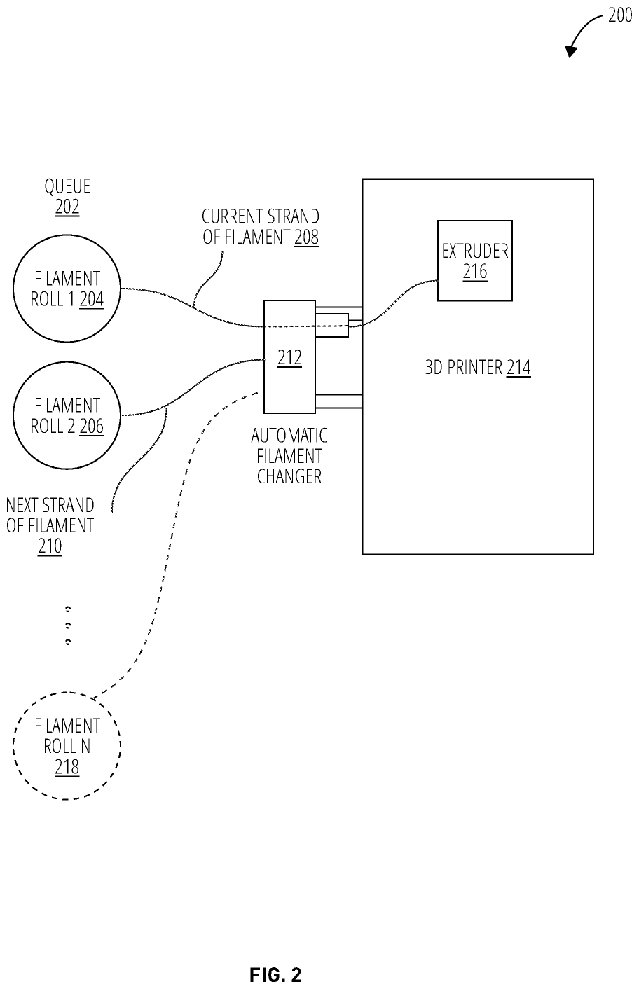

Referring to FIG. 2, the 3D printer system with automatic filament change apparatus 200 comprises a queue 202, a filament roll 1 204, a filament roll 2 206, a current strand of filament 208, a next strand of filament 210, an automatic filament changer 212, a 3D printer 214, an extruder 216, and a filament roll n 218.

Filament roll 1 204 may be loaded into the queue 202 by the operator. At this time, or any time before filament roll 1 204 runs out, the operator may also load filament roll 2 206, filament roll 3, up to filament roll n 218, depending on how many rolls the queue will hold. A typical embodiment may have a queue of two filament rolls.

The strand of filament from filament roll 1 204 may be fed into the automatic filament changer 212. The automatic filament changer 212 includes a feed motor that may move the filament through the automatic filament changer 212 to the extruder 216 of a 3D printer 214. The strand(s) of filament from filament roll 2 206 through filament roll n 218 may also be fed into the automatic filament changer 212.

As the current strand of filament 208 from filament roll 1 204 runs out, this may be detected by a sensor. When this happens, the automatic filament changer 212 may automatically begin feeding the next strand of filament 210 to the extruder 216.

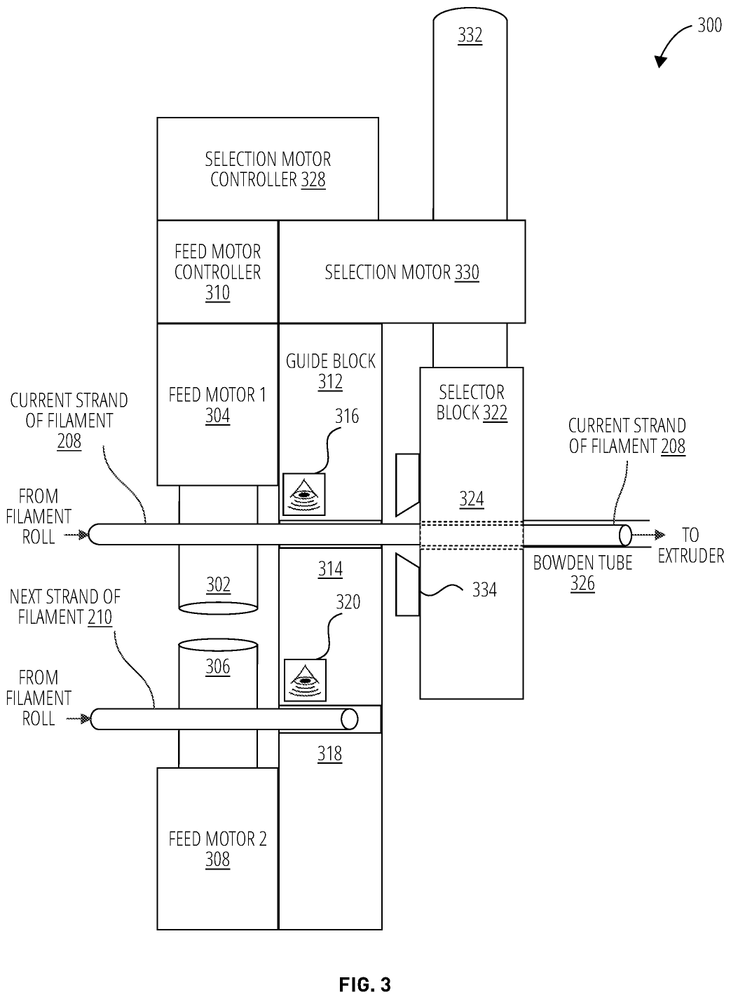

The system may incorporate some means of alerting the operator when one of the filament rolls runs out. An alert may be signaled by means of a notification light, and audible alarm, or a network notification, that filament roll 1 204 is empty. Logic to activate the alerts may be incorporated into an alert control system on the automatic filament change apparatus. In a typical embodiment the end sensor may be capable of sending an output signal to activate an alert. A signal to activate an alert may also be sent by means of a computer terminal, or the 3D printer, in addition to the end sensor. The apparatus may also include a hardware mechanism that allows the operator to manually trigger a filament change. The operator may then replace filament roll 1 204 as the 3D printer 214 prints using filament from one of the other filament rolls in the queue 202. The mechanisms that may actuate this process at the automatic filament changer 212 are shown in more detail in FIG. 3.

Referring to FIG. 3, the automatic filament changer 300 comprises a roller 1 302, a feed motor 1 304, a roller 2 306, a feed motor 2 308, a feed motor controller 310, a guide block 312, an input port 1 314, an end sensor 1 316, an input port 2 318, an end sensor 2 320, a selector block 322, an output port 324, a Bowden tube 326, a selection motor controller 328, a selection motor 330, a lead screw 332, and blades 334.

In an embodiment of the disclosed design, an automatic filament changer 300 may have two input positions, configured to accept two strands of filament from two filament rolls. The first input position may direct a strand of filament across roller 1 302, powered by feed motor 1 304. The second input position may direct a strand of filament across roller 2 306, powered by feed motor 2 308. Feed motor 1 304 and feed motor 2 308 may be Bowden drive stepper motors equipped with a slip-free frictional rubber or other drive mechanism (represented here by roller 1 302 and roller 2 306). In some embodiments the drive mechanism may be a soft rubber wheel on the output shaft of the stepper or a neoprene belt along with a few rollers, increasing the contact area of the motor's output on the filament. It is important that the drive mechanism impart a relatively large frictional force on the element without crushing it with pressure or deforming it with teeth. This avoids damage to the filament, deposition of filament residue, or other effects that may impact the longevity of the mechanism.

Feed motor 1 304 and feed motor 2 308 may be controlled by a feed motor controller 310. The feed motor controller 310 may control the feed motor of the active input port so as to impart a feeding force upon the active filament, while maintaining the feed motors for the inactive input port(s) in an idle state. The feed motor controller 310 may receive input from end sensors, such that when a tail end is detected at an input port, that feed motor goes idle, and remains idle, even when the associated input port is selected, unless the associated end sensor senses filament at the port. The feed motor controller 310 may carefully limit maximum motor torque, which correlates directly to force on the filament, to a relatively low value. Depending on the system, certain embodiments may work well with 1N to 10N of force.

The extruder located on the 3D printer may include a motor intended to exert a pulling force on a strand of filament, in order to continuously feed filament directly from a roll. Under some operational conditions, the motor at the extruder may reverse direction, to back filament away from its printing nozzle. The automatic filament changer 300 may be carefully designed such that the feed motors may be back driven. This means that, should a force be exerted on a strand of filament in opposition to the driving force of the feed motor, the feed motor may accommodate that opposing force, allowing the filament to move backwards through the input and output ports, as well as forward. In this case, the stepper may electrically slip and torque limit, so as not to damage the filament. This may further ensure that there is no mechanical slippage between the filament and motor drive mechanism.

The feed motor controller 310 may accept operator input or send status to the operator through a network connection or user interface. The feed motor controller 310 may include memory to maintain an operation log for the feed motors.

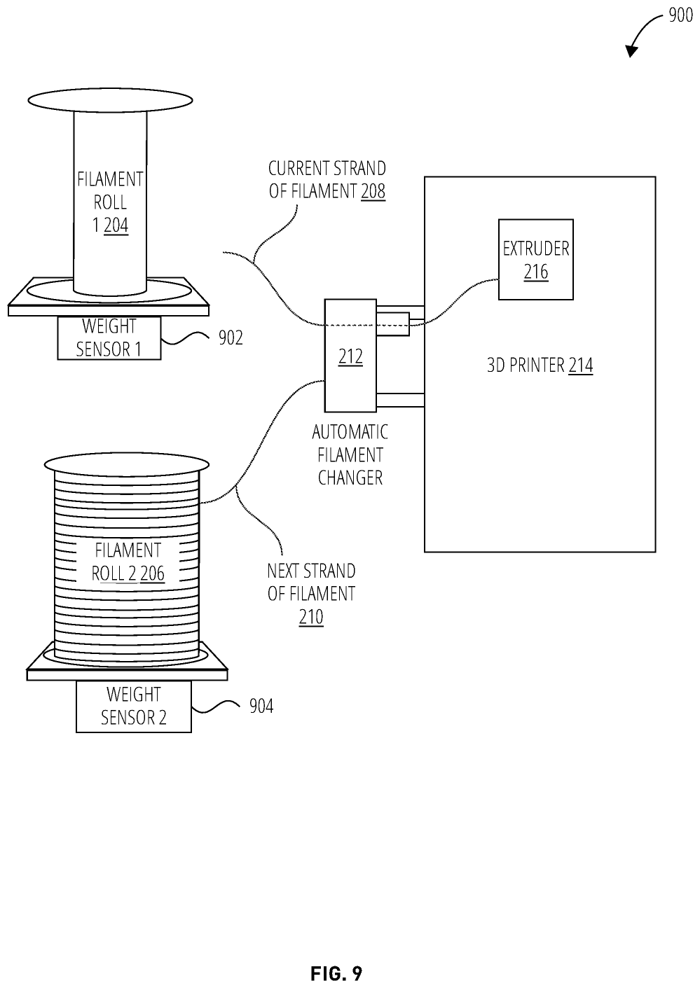

At the end of the feed motors, the two filaments may run into guide block 312, configured with an input port 1 314 and an input port 2 318. Each filament may run past an end sensor (end sensor 1 316 and end sensor 2 320, respectively) that detects the presence of the filament. In some embodiments, this may be an optical sensor or a microswitch. End sensors in some embodiments may include weight sensors at each position in the queue (see FIG. 9). The input ports in the guide block 312 may be configured to align with a single output port 324 in a selector block 322.

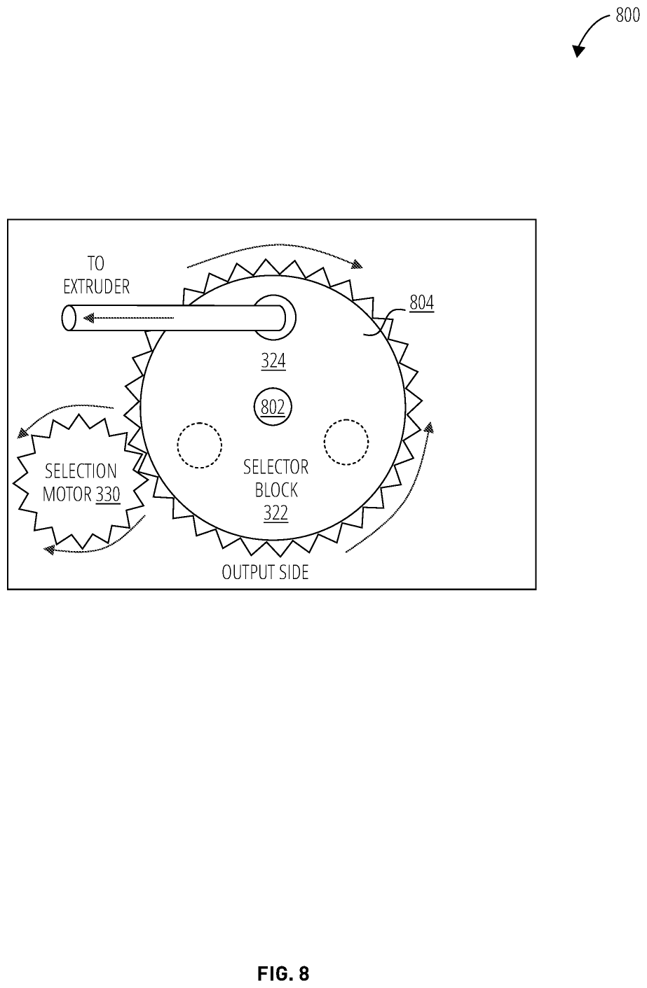

The output port 324 may be flanked by cutting blades 334. In some embodiments these may be straight blades or curved blades. In other embodiments, the blade may be a hole with a sharpened interior edge. The selector block 322 output port 324 may be aligned with one of the two input ports in the guide block 312 by means of a selection motor 330. In some embodiments, this may be a high-powered motor on a lead screw 332. In other embodiments, this may be a rotating wheel mechanism with a motor on the periphery (see FIG. 8).

The selection motor 330 may be controlled by a selection motor controller 328. The selection motor controller 328 may receive input from the end sensors and may use this input to determine if a position has filament present to feed. The selection motor controller 328 may instruct the selection motor 330 to reposition the selector block 322 so as to accept the filament fed from a new input port. The selection motor controller 328 may accept operator input or send status to the operator through a network connection or user interface. the selection motor controller 328 may include memory to maintain and operation log for the selection motor 330.

The current strand of filament 208 exits the output port 324 through a Bowden tube 326. The Bowden tube 326 extends all the way to the extruder 216 of the 3D printer 214, keeping the filament aligned with the extruder mechanism and allowing the extruder to exert a pulling force on the filament as the filament is used up.

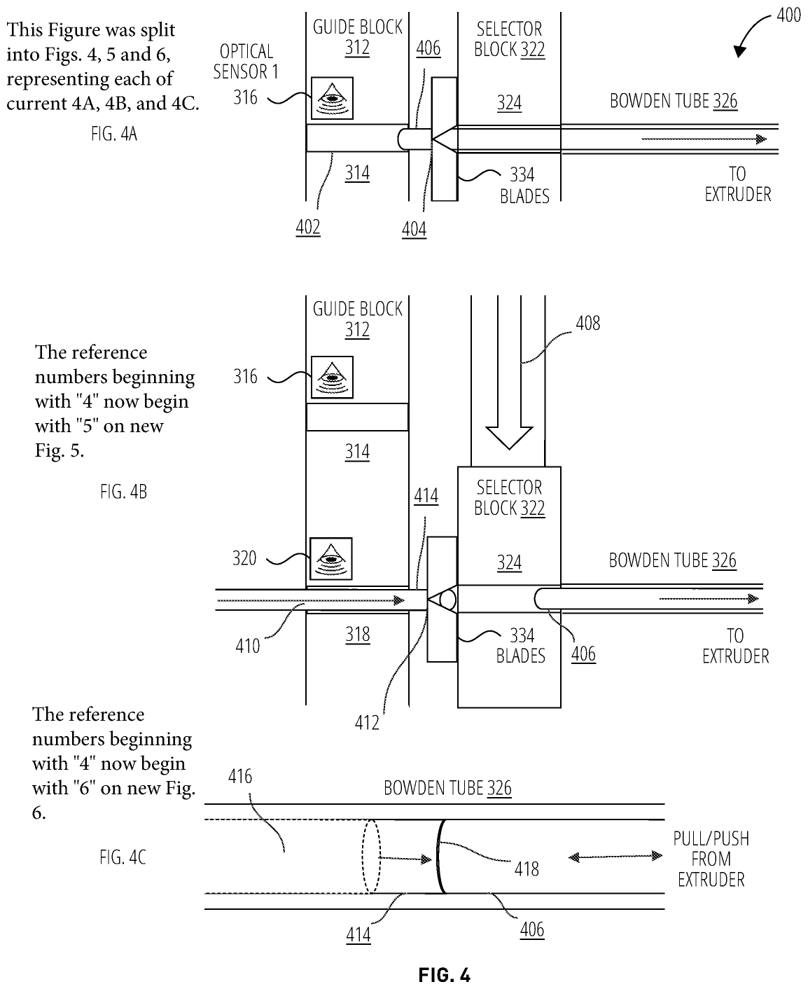

Referring to FIG. 4, the automatic filament change illustration 400 illustrate a number of key steps in the automatic filament change process. A filament change may be triggered manually by an operator, but in the embodiment shown in FIG. 4, end sensor 1 316 detects an absence of filament (as shown at 402). The sensor may be an optical sensor, a microswitch, or a weight sensor (see FIG. 9). An optical sensor is shown in this embodiment. Embedded blades 334 may cut a smooth face on the tail end 406 of the existing filament before shifting to another input port (as shown at 404). While the blades 334 in this embodiment are shown between the guide block 312 and selector block 322, other embodiments may locate one or more blades or sets of blades at either end of the input ports and/or output port, wherever the particular design configuration renders it convenient and effective for the purposes disclosed herein.

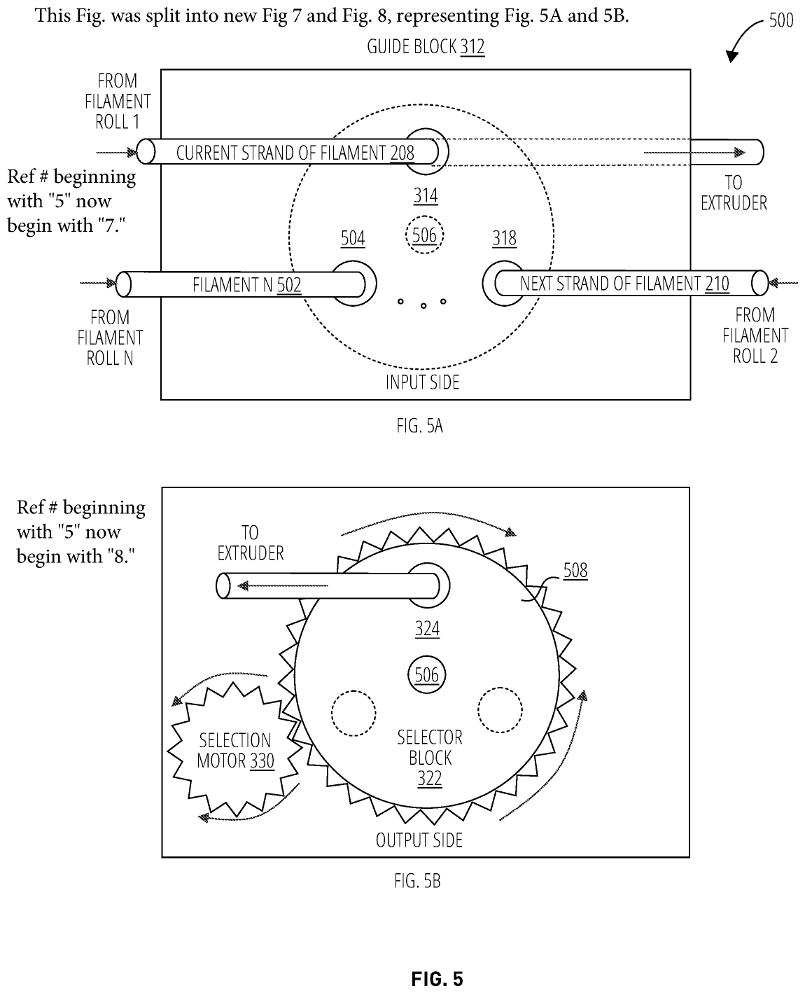

Referring to FIG. 5, an automatic filament change illustration 500 comprises a guide block 312, an input port 1 314, an end sensor 1 316, an input port 2 318, an end sensor 2 320, a selector block 322, an output port 324, a Bowden tube 326, blades 334, a tail end 502, and a lead end 510.

FIG. 5 shows how the selector block 322 may be rapidly shifted over to the other input port in the guide block 312 by the selection motor (shown at 504). The feed motor may begin to feed the new filament through the input port 2 318 (shown at 506). The blades 334 may cut a smooth face on the lead end 510 of the new filament before it enters the output port (as shown at 508).

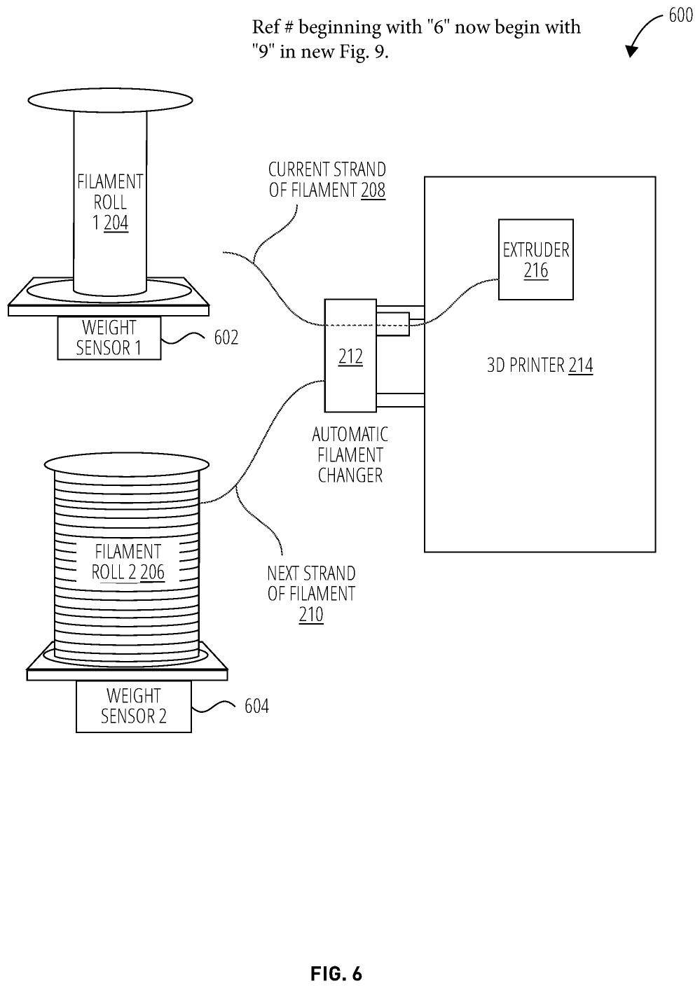

Referring to FIG. 6, an automatic filament change illustration 600 comprises a Bowden tube 326, a tail end 602, and a lead end 604.

FIG. 6 shows the feed motor behind the new input port may then push the new filament forward at a constant rate slightly higher than the rate of filament consumption by the printer (as shown at 606). This may drive the new filament to push against the old filament where the two filaments meet within the tube (typically a Bowden tube) connecting it to the printer's main direct drive extruder (as shown at 608). Torque limiting in the feed motor controller may allow the extruder to push back and retract or other operations without interference from the feed motor (typically a Bowden motor). Once the extruder has latched onto the new filament, the feed motor may continue applying gradual force, or may go idle and allow the extruder to pull feed the filament.

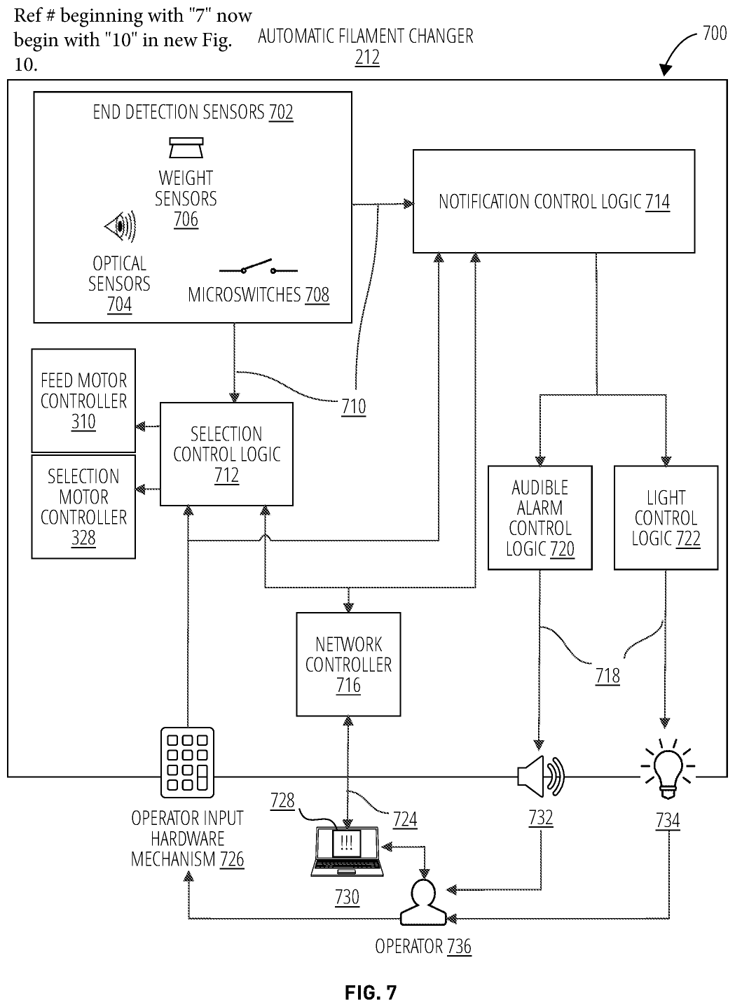

Referring to FIG. 7 and FIG. 8, a rotary output port 700 in accordance with one embodiment comprises a current strand of filament 208, a next strand of filament 210, a guide block 312, an input port 1 314, an input port 2 318, a selector block 322 in the form of a rotating wheel mechanism 804, an output port 324, a selection motor 330, a filament n 702, and an input port n 704.

In the input side of this embodiment, multiple input ports may be configured in a guide block 312, configured in a circular array, i.e., equidistant from a central pivot point 706. Each input port may accept a strand of filament from a filament roll. For the purposes of this example, the current strand of filament 208 from filament roll 1 is shown as routed to input port 1 314. The next strand of filament 210 from filament roll 2 is shown as routed to input port 2 318. Additional strands of filament are represented by filament n 702, from filament roll n, routed to input port n 704. As in the linear embodiment, shown in FIG. 3, the input ports may be stationary with regard to a main body of the automatic filament change apparatus. While not shown in this figure, rollers and feed motors may be used to provide a feed force as needed upon whichever strand of filament is being fed to the extruder, as shown in FIG. 3.

Referring to FIG. 8, the output side of this embodiment, rotary output port 800, can be seen. The selector block 322, instead of moving linearly along a lead screw, as shown in FIG. 3 and FIG. 4, may be designed as a rotating wheel mechanism 804, rotating around a pivot point 802. The selection motor 330 may include a toothed or geared periphery that interlocks with a tooth or geared periphery of the selector block. The selection motor 330 may be controlled by a selection motor controller such that it may rotate the selector block through a series of rotational angles, in one or both directions, in order to align the output port 324 with one of the n input ports.

Referring to FIG. 9, a 3D printer system with weight sensor 900 may comprise a filament roll 1 204, a filament roll 2 206, a current strand of filament 208, a next strand of filament 210, an automatic filament changer 212, a 3D printer 214, an extruder 216, a weight sensor 1 902, and a weight sensor 2 904. Instead of or in addition to the end sensor described in the embodiments above, weight sensors may be implemented at each position in the queue to detect when the filament roll at that queue position has run out of filament.

As illustrated in this figure, a current strand of filament 208 may have just detached from filament roll 1 204. Weight sensor 1 902 may detect, based on the known empty weight of a filament roll, that filament roll 1 204 has run out of filament. The sensor may communicate with the automatic filament changer 212 and an operator over a wired or wireless network connection. Based on the empty roll weight being reached, the automatic filament changer 212 may immediately switch to the next strand of filament 210 on filament roll 2 206.

Alternately, the feed motor controller may calculate, based on a conservative estimate of filament length left once the roll itself runs out completely, and a known feed motor rate, a more exact approximation of when the tail end of the current strand of filament 208 will pass through the input port of the automatic filament changer 212. The feed motor controller may communicate with the selection motor controller in order to switch the output port to the next input port based on that time estimate.

Introducing a weight sensor may facilitate additional functional applications using the automatic filament change apparatus. Multiple colors of filament may be loaded for a multi-colored 3D printed design. Known parameters for the print job in progress, as well as weight data from the sensor under each filament roll, may be used to switch to a new filament color at the correct time as the job is in progress. In embodiments where the automatic filament change apparatus may actively alert an operator when filament roll status changes, weight data and print job parameters may be used to determine whether or not a filament roll might be expected to run out before the job in progress completes. If all other positions in the queue are empty when such a situation is detected, a high priority alert may be sent to notify an operator that new filament rolls are needed to prevent a print failure.

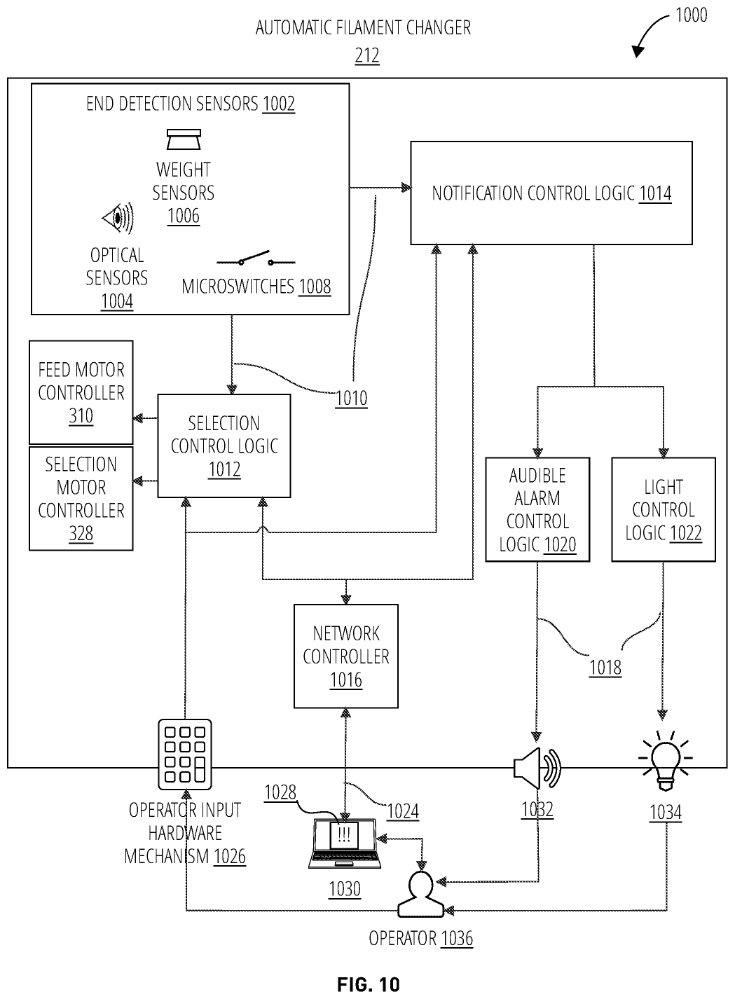

Referring to FIG. 10, the automatic filament change apparatus alarm/notification system 1000 may comprise end detection sensors 1002, selection control logic 1012, notification control logic 1014, a network controller 1016, audible alarm control logic 1020, light control logic 1022, a network connection 1024, an operator input hardware mechanism 1026, a computer terminal 1030, an audible alarm 1032, and a notification light 1034. The automatic filament changer 212 may incorporate these components or may connect to external components that provide the necessary functionality.

As described above, end detection sensors 1002 may include some combination of optical sensors 1004, weight sensors 1006, and/or microswitches 1008. When the sensors detect the tail end of a strand of filament or detect that a filament roll has run out of filament, a signal 1010 may be sent to selection control logic 1012, which may in turn signal the feed motor controller 310 and selection motor controller 328 to automatically change the filament fed to the extruder. In addition, the end detection sensors 1002 may send a signal 1010 to notification control logic 1014, in order to alert an operator 1036 that an empty filament roll needs to be replaced.

The notification control logic 1014 may include or connect to audible alarm control logic 1020. The audible alarm control logic 1020 may send an output signal 1018 to an audible alarm 1032, which may sound an alert to notify the operator 1036 of an empty filament roll. The audible alarm 1032 may be integrated into the automatic filament changer 212. The audible alarm 1032 may alternately be external to the automatic filament changer 212 and may receive the output signal 1018 over a wired or wireless connection. The notification control logic 1014 may include or connect to light control logic 1022. The light control logic 1022 may send an output signal 1018 to a notification light 1034, which may generate a visible notification of an empty filament roll. The notification light 1034 may be integrated into the automatic filament changer 212 or may be external to the automatic filament changer 212 and receive the output signal 1018 over a wired or wireless connection. In a preferred embodiment, a notification light 1034 may be installed at each filament roll position in the queue, such that an operator may see from a distance which queue position requires a new filament roll.

The notification control logic 1014 may also communicate over a local or wide area network, either wired or wireless, by means of a network controller 1016. The network controller 1016 may allow for a network connection 1024 with a computer terminal 1030 accessible by the operator 1036. In this manner, a network notification 1028 may be displayed on the operator's computer terminal 1030 to alert the operator 1036 to the need for a new filament roll. This capability may additionally allow for a more urgent level of communication to be made beyond the physical confines of the printer and automatic filament changer 212 location. In some embodiments, the network controller 1016 may also communicate with the selection control logic 1012. In this manner, the operator 1036 may be able to command the selection control logic 1012 to switch to a new input port, regardless of whether the end detection sensors 1002 have detected the tail end of a strand of filament.

The automatic filament changer 212 may further include or connect to an operator input hardware mechanism 1026. This may be a keypad, a set of buttons or switches, or some other configuration allowing the operator 1036 to interact with the automatic filament changer 212. In some embodiments, the operator may be able to cancel notifications and alarms by means of the operator input hardware mechanism 1026 once the empty filament roll has been replaced. In some embodiments, the operator 1036 may be able to use the operator input hardware mechanism 1026 to manually switch the automatic filament changer 212 to a new input port.

The method and apparatus in this disclosure are described in the preceding on the basis of several preferred embodiments. Different aspects of different variants are considered to be described in combination with each other such that all combinations that upon reading by a skilled person in the field on the basis of this document may be regarded as being read within the concept of the invention. The preferred embodiments do not limit the extent of protection of this document.

In addition, as used herein, the wording “and/or” is intended to represent an inclusive- or. That is, “X and/or Y” is intended to mean X or Y or both, for example. As a further example, “X, Y, and/or Z” is intended to mean X or Y or Z or any combination thereof.

Having thus described embodiments of the present invention of the present application in detail and by reference to illustrative embodiments thereof, it will be apparent that modifications and variations are possible without departing from the scope of the present invention.

What is claimed is:

1. A method for automatic filament change, the method comprising:
loading a plurality of filament rolls into a queue, each of the filament rolls containing a strand of filament for use as a print medium for a three-dimensional printer;
feeding a lead end of the strand of filament to the three-dimensional printer;
detecting a tail end of the strand of filament as the filament roll runs out of the strand of filament; and
automatically feeding the lead end of a next strand of filament from a next filament roll immediately behind the tail end of the strand of filament from the filament roll that is running out of the strand of filament.

2. The method of claim 1, further comprising, on condition that at least one of the filament rolls in the queue is not empty, repeating the feeding, detecting, and automatically feeding steps.

3. The method of claim 1, further comprising cutting the lead ends and the tail ends such that the lead end from the next filament roll and the tail end from the filament roll that is running out of the strand of filament meet at a smooth face.

4. The method of claim 1, further comprising alerting an operator when at least one of the filament rolls is empty.

5. An automatic filament change apparatus comprising:
a plurality of input ports, wherein each of the input ports accepts a strand of filament from a filament roll in a queue;
an output port, wherein the output port directs the strand of filament to a three- dimensional printer;
an end sensor capable of detecting a tail end of the strand of filament as it passes out of the input port;
a feed motor, wherein the feed motor propels the strand of filament through the input port and the output port;
a feed motor controller, wherein the feed motor controller controls the feed motor;
a selection motor, wherein the selection motor aligns the output port with one of the input ports; and
a selection motor controller, wherein the selection motor controller controls the selection motor to align the output port with the input port selected by the selection motor controller.

6. The automatic filament change apparatus of claim 5, further comprising a blade for cutting a smooth face at each end of the strand of filament.

7. The automatic filament change apparatus of claim 6, wherein the blade comprises one or more straight blades.

8. The automatic filament change apparatus of claim 6, wherein the blade comprises one or more curved blades.

9. The automatic filament change apparatus of claim 6, wherein the blade comprises a hole with a sharpened interior edge.

10. The automatic filament change apparatus of claim 5, further comprising at least one of:
a notification light for each of the input ports and light control logic capable of accepting a signal from the end sensor and sending an output signal to activate the notification light for the input port associated with it when the tail end of the strand of filament at the input port runs out;
an audible alarm and audible alarm control logic capable of accepting the signal from the end sensor and sending the output signal to activate the audible alarm when the tail end of the strand of filament at the input port runs out; and
a network connection to at least one computer terminal and notification control logic capable of accepting the signal from the end sensor and sending a network notification when the tail end of the strand of filament at the input port runs out.

11. The automatic filament change apparatus of claim 5, further comprising a weight sensor at each of the filament rolls in the queue, wherein the weight sensor can be calibrated when the filament roll is loaded in the queue, such that the weight sensor may detect when the filament roll runs out of filament.

12. The automatic filament change apparatus of claim 5, wherein the end sensor is an optical sensor.

13. The automatic filament change apparatus of claim 5, wherein the end sensor is a microswitch.

14. The automatic filament change apparatus of claim 5, further comprising at least one of:
a hardware mechanism by which an operator triggers a filament change; and
a network connection to at least one computer terminal and selection control logic capable of accepting a signal over the network connection to trigger the filament change.

15. The automatic filament change apparatus of claim 5, wherein the feed motor is a Bowden drive stepper motor.

16. The automatic filament change apparatus of claim 5, wherein the selection motor is a motor on a lead screw.

17. The automatic filament change apparatus of claim 5, wherein the output port is located on a rotating wheel mechanism with the selection motor on a periphery of the rotating wheel mechanism.

18. The automatic filament change apparatus of claim 5, wherein the selection motor acts upon a mechanism that includes the input ports, to align the input port selected by the selection motor controller with the output port.

19. The automatic filament change apparatus of claim 5, wherein the selection motor acts upon a mechanism that includes the output port, to align the input port selected by the selection motor controller with the output port.
